(19) United States
(12) Patent Application Publication
(10) Pub. No.: US 2025/0162079 A1
(43) Pub. Date: May 22, 2025

(54) GLASS PROCESSING METHOD AND GLASS PROCESSING DEVICE OF PERFORMING THE SAME

(71) Applicant: SAMSUNG DISPLAY CO., LTD., YONGIN-SI (KR)

(72) Inventors: HYUN CHUL JUNG, Yongin-si (KR); BYOUNGYUL SHIM, Yongin-si (KR); KANG DUK CHOI, Yongin-si (KR)

(21) Appl. No.: 18/954,701

(22) Filed: Nov. 21, 2024

(30) Foreign Application Priority Data
Nov. 22, 2023 (KR) 10-2023-0163392

(51) Int. Cl. B23K 26/36; B23K 26/08; B23K 37/04; B23K 103/00; C03B 23/00

(52) U.S. Cl. CPC B23K 26/36; B23K 26/083; B23K 37/0443; C03B 23/0013; B23K 2103/54

(57) ABSTRACT

Provided is a method comprising form a primary processed glass including a bottom surface and a side wall extending in a direction crossing from the bottom surface and having a curvature by applying heat and pressure to a preliminary glass, seating the primary processed glass on a first part of a jig, and the jig including a first part, a second part protruding from the first part and in contact with a portion of the side wall, and a third part which rotates the first part, fixing a laser at a second position spaced apart from a first position where a jig assembly including a jig on which the primary processed glass is seated is positioned, moving the jig assembly to the second position, and forming a cover glass by the laser to ablate some portions of the side wall of the primary processed glass at the second position.

### CROSS-REFERENCE TO RELATED APPLICATION

This application claims priority under 35 U.S.C. § 119 to Korean Patent Application No. 10-2023-0163392, filed on Nov. 22, 2023, in the Korean Intellectual Property Office, the content of which is incorporated by reference herein in its entirety.

### BACKGROUND

### 1. Technical Field

The present disclosure generally relates to a glass processing method. More specifically, the present disclosure relates to a processing method of a cover glass having a curvature and a glass processing device that performs the same.

### 2. Discussion of Related Art

The significance of a display device as a medium for connecting a user and information is becoming more and more apparent as information technology advances. For example, different kinds of display devices are widely utilized in different sectors. Examples of these include liquid crystal displays (LCDs), organic light-emitting displays (OLEDs), plasma displays (PDPs), quantum dots displays, and the like.

A cover glass generally is disposed on a front surface of a display panel included in the display device to protect the display panel. The cover glass includes a transparent material so that images or data displayed on the panel can be viewed.

In many instances, the cover glass is attached to an outer surface of the display panel to protect the display panel. The cover glass has various shapes and properties.

### SUMMARY

An embodiment of the present disclosure provides a glass processing method.

An embodiment of the present disclosure provides a glass processing device using the glass processing method.

A glass processing method according to an embodiment of the present disclosure includes forming a primary processed glass including a bottom surface and a side wall extending in a direction crossing from the bottom surface and having a curvature by applying heat and pressure to a preliminary glass, seating the primary processed glass on a first part of a jig, and the jig including a first part, a second part protruding and extending from the first part and in contact with a portion of the side wall, and a third part which rotates the first part, fixing a laser at a second position spaced apart from a first position where a jig assembly including a jig on which the primary processed glass is seated is positioned, moving the jig assembly to the second position, and forming a cover glass by the laser ablation to remove a portion of the side wall of the primary processed glass at the second position.

In an embodiment, forming the primary processed glass may be accomplished by disposing the preliminary glass between a lower mold and an upper mold disposed in a chamber and pressurizing the preliminary glass while reducing a separation distance between the upper mold and the lower mold.

In an embodiment, the chamber, the lower mold, and the upper mold may be heated.

In an embodiment, a height of an upper surface of the side wall of the primary processed glass might not be constant at the first position.

In an embodiment, a height of an upper surface of the side wall of the cover glass may become constant after the laser ablation at the second position.

In an embodiment, the height of the upper surface of the side wall of the cover glass may be equal to a height of an upper surface of the second part of the jig.

In an embodiment, the jig assembly linearly may move from the first position to the second position, and at the second position, the laser may remove some portions of the side wall of the primary processed glass while the jig assembly is rotated around an imaginary axis passing through a middle of the jig assembly.

In an embodiment, at the second position, the laser may remove some portions of the side wall of the primary processed glass while the jig assembly rotates one or more times around the imaginary axis.

In an embodiment, the primary processed glass may be fixed to the jig by suction pressure provided from the first part of the jig.

In an embodiment, the jig may be plural, and the plurality of jigs may be sequentially moved from the first position to the second position.

A glass processing device includes a jig including a first part on which a primary processed glass including a bottom surface and a side wall extending in a direction crossing from the bottom surface and including a double curved surface is seated, a second part in contact with a portion of the side wall of the primary processed glass protruding and extending from the first part, and a third part attached to the first part, wherein the jig rotates around an imaginary axis passing through a middle of the third part, a laser that is fixed to a second position spaced apart from a first position where a jig assembly including the jig on which the primary processed glass is seated is positioned, and wherein the laser ablates some portions of the side wall of the primary processed glass at the second position, and a driving device that transports the jig from the first position to the second position.

In an embodiment, the glass processing device may further include a chamber, a lower mold disposed in the chamber, and an upper mold positioned above the lower mold in the chamber, wherein the lower mold and the upper mold are spaced apart from each other by a separation distance, and wherein the separation distance between the lower mold and the upper mold is adjustable.

In an embodiment, the chamber, the lower mold, and the upper mold may be heated.

In an embodiment, a height of an upper surface of the side wall of the primary processed glass may not be constant at the first position.

In an embodiment, a height of an upper surface of the side wall of the primary processed glass that passes the second position may become constant after the second position.

In an embodiment, the height of the upper surface of the side wall of the primary processed glass that passes the second position may be equal to a height of an upper surface of the second part of the jig.

In an embodiment, the driving device may linearly move the jig assembly from the first position to the second position, and at the second position, the laser may remove some portions of the side wall of the primary processed glass while the jig assembly is rotated around the imaginary axis.

In an embodiment, at the second position, the laser may remove some portions of the side wall of the primary processed glass while the jig assembly rotates one or more times around the imaginary axis.

In an embodiment, a hole may be defined in the first part of the jig, and a suction pressure may be provided in the hole to fix the primary processed glass to the jig.

A glass processing method according to an embodiment of the present disclosure comprises: forming a primary processed glass including a bottom surface and a side wall extending in a direction crossing from the bottom surface and having a curvature by applying heat and pressure to a preliminary glass; seating the primary processed glass on a first part of a jig, and the jig including a first part, a second part protruding from the first part and in contact with a portion of the side wall, and a third part attached to the first part; fixing a laser at a second position spaced apart from a first position where a jig assembly including a jig on which the primary processed glass is seated is positioned; moving the jig assembly to the second position; and forming a cover glass by using the laser ablation to remove a portion of the side wall of the primary processed glass at the second position, wherein the forming of the primary processed glass is accomplished by: disposing the preliminary glass between a lower mold and an upper mold disposed in a chamber, and pressurizing the preliminary glass while reducing a separation distance between the upper mold and the lower mold, wherein the jig assembly linearly moves from the first position to the second position, and wherein at the second position, the laser ablates some portions of the side wall of the primary processed glass while the jig assembly is rotated around an imaginary axis passing through a middle of the jig assembly.

A glass processing method and a glass processing device using the method according to embodiments of the present disclosure may include forming a primary processed glass including a bottom surface and a side wall extending in a direction crossing from the bottom surface and having a curvature by applying heat and pressure to a preliminary glass, seating the primary processed glass on a first part of a jig, and the jig including a first part, a second part protruding and extending from the first part and in contact with a portion of the side wall, and a third part which rotates the first part, fixing a laser at a second position spaced apart from a first position where a jig assembly including a jig on which the primary processed glass is seated is positioned, moving the jig assembly to the second position, and forming a cover glass by using the laser to remove a portion of the side wall of the primary processed glass at the second position. Accordingly, regardless of a shape of the primary processed glass, a burr may be removed and the primary processed glass may be processed so that the level of the side wall may be constant.

In addition, the glass processing method and the glass processing device using the same may include a plurality of the jigs. The plurality of jigs may continuously process the primary processing glass by the laser while sequentially moving in one direction. Accordingly, a yield may be improved.

### BRIEF DESCRIPTION OF THE DRAWINGS

The accompanying drawings, which are included to provide a further understanding of the present invention, illustrate embodiments of the present disclosure together with the description thereof, in which:

FIG. 1 is a perspective view of a display device according to an embodiment of the present disclosure;

FIG. 2 is a perspective view of a cover glass included in the display device of FIG. 1 according to an embodiment;

FIG. 3 is a cross-sectional view taken along line I-I′ of FIG. 2;

FIG. 4 is a perspective view of a cover glass according to a comparative embodiment;

FIG. 5 is a cross-sectional view taken along line II-II′ of FIG. 4;

FIGS. 6, 7, and 8 are views illustrating the glass processing device according to an embodiment of the present disclosure;

FIG. 9 is a view illustrating a glass processing device according to a comparative embodiment;

FIGS. 10, 11, 12, 13, 14, 15, and 16 are views illustrating a glass processing method according to an embodiment of the present disclosure.

### DETAILED DESCRIPTION

Illustrative, non-limiting embodiments of the present disclosure will be more clearly understood from the following detailed description in conjunction with the accompanying drawings.

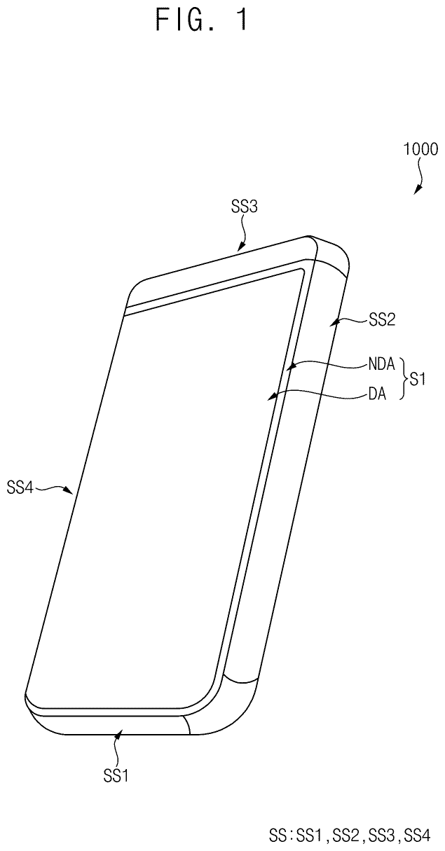

FIG. 1 is a perspective view of a display device according to an embodiment of the present disclosure.

Referring to FIG. 1, in a plan view, a display device 1000 according to an embodiment includes a display area DA and a peripheral area NDA.

The plane may be defined by a first direction and a second direction. The second direction may cross the first direction. For example, the first direction and the second direction may be perpendicular to each other.

The display area DA may be an area that displays an image. To this end, a plurality of pixels may be arranged in the display area DA.

For example, the plurality of pixel may emit light in a third direction. The third direction may cross both the first direction and the second direction. For example, the first direction, the second direction, and the third direction may be perpendicular to each other.

The peripheral area NDA may surround the display area DA. A driver for driving the plurality of pixels arranged in the display area DA may be disposed in the peripheral area NDA.

However, the present disclosure is not limited thereto. For example, the plurality of pixel may be disposed in the peripheral area NDA. In this case, the image may be displayed along the peripheral area NDA. For another example, the peripheral area NDA may be omitted. In this case, the driver may be disposed in the display area DA.

The display device 1000 may have various shapes. For example, the display device 1000 may have various shapes, such as a rectangular parallelepiped, a rectangular parallelepiped with cut corners, or a cylinder. However, the present disclosure is not limited thereto.

For example, the display device 1000 may include a front surface S1, a rear surface facing the front surface S1 in the third direction, and a side surface SS. The side surface SS may extend in a direction crossing the front surface S1 and the rear surface (i.e., the third direction).

For example, the side surface SS may include a first side SS1, a second side SS2, a third side SS3, and a fourth side SS4. For example, the first side surface SS1 is a bottom side surface, the second side surface SS2 is a right side surface, the third side surface SS3 is a top side surface, and the fourth side surface SS54 is a left side surface. In this case, the first side SS1 and the third side SS3 may be parallel to each other in the second direction. The second side SS2 and the fourth side SS4 may be parallel to each other in the first direction. In other words, the first side SS1 and the second side SS2 may cross each other, and the third side SS3 and the fourth side SS4 may also cross each other. In addition, the first side SS1 and the fourth side SS4 may cross each other, and the second side SS2 and the third side SS3 may also cross each other. However, the present disclosure is not limited thereto.

For example, a user of the display device 1000 may operate the display device 1000 by touching the front surface S1 (e.g., the display area DA of the front surface S1). However, the present disclosure is not limited thereto. For example, the image may be displayed from one or all of the side surface SS. In this case, the user of the display device 1000 may manipulate the display device 1000 by touching the side surface SS.

The display device 1000 of FIG. 1 is illustrative and may be changed in various ways. For example, the shape and structure of the display device 1000 may be changed in various ways. For example, the display device 1000 may be a flexible display device, a slidable display device, or the like. In this case, the display device 1000 may further include a foldable surface. The foldable surface may be elastically deformed by external force. Accordingly, the display device 1000 may be folded on the foldable surface.

As another example, although the display device 1000 of FIG. 1 is shown as a smartphone, the present disclosure is not limited thereto. For example, the display device 1000 may be a smart watch or a similar display device. In this case, the side surface SS of the display device 1000 may be a single curved surface connecting the front surface S1 and the rear surface. The single curved surface may refer to a curved surface (e.g., a cylinder, etc.) created by a movement of a straight line.

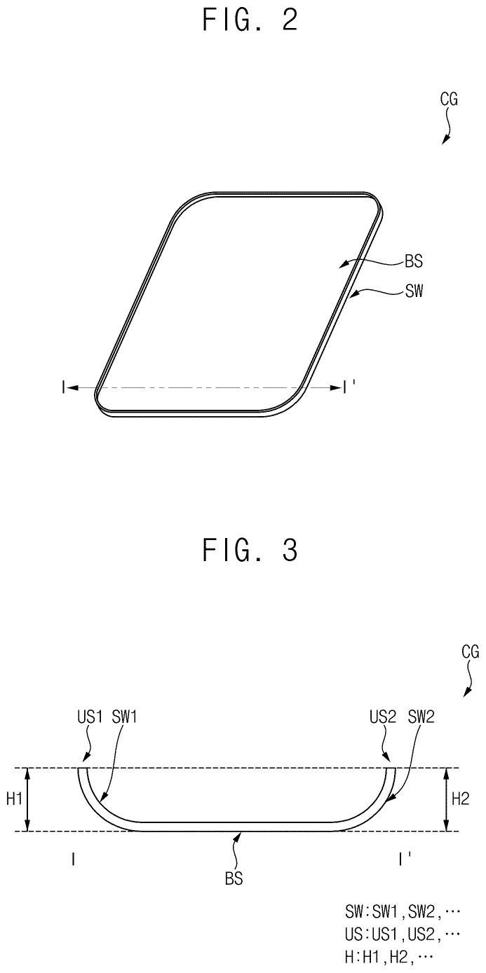

FIG. 2 is a perspective view of a cover glass included in the display device of FIG. 1 according to an embodiment.

Referring to FIGS. 1 and 2, to protect the surface of the display device 1000, in an embodiment, a cover glass CG includes a bottom surface BS and a side wall SW.

For example, as described above with reference to FIG. 1, the display device 1000 displays the image on the front surface S1 and/or the side surface SS. In this case, the cover glass CG may be disposed on both the front surface S1 and the side surface SS to protect the surface of the display device 1000.

For example, the bottom surface BS may have a substantially flat surface. However, the bottom surface may have a curved surface. In this case, the bottom surface BS may cover the front surface S1 of the display device 1000. The bottom surface BS may protect the front surface S1 of the display device 1000 by a foreign material and damage by an external force.

In an embodiment, the side wall SW may protrude from the bottom surface BS in a direction crossing the bottom surface BS. For example, the bottom surface BS may be parallel to the plane defined by the first direction and the second direction, and the side wall SW may protrude from the bottom surface BS in the third direction which is perpendicular to the first and second directions. The side wall SW may have a substantially flat wall. However, the side wall SW may have a curved wall. The side wall SW may cover the side surface SS of the display device 1000. The side wall SW may protect the side surface SS of the display device 100 by a foreign material and the damage by external force.

In an embodiment, the side wall SW may include a double curved surface. The double curved surface may mean a curved surface (e.g., a sphere, etc.) created by the movement of the curve. In this case, the front of the display device having a rectangular parallelepiped shape with the corners cut (e.g., the front surface S1 of FIG. 1), and the plurality of side surfaces (e.g., the side surface SS of FIG. 1).

As depicted in FIG. 2, the side wall SW of the cover glass CG includes the double curved surface as the display device 1000 has the rectangular parallelepiped shape with the corners cut, however, the present disclosure is not limited thereto. The shape and structure of the cover glass CG may be various depending on the shape and structure of the display device 1000.

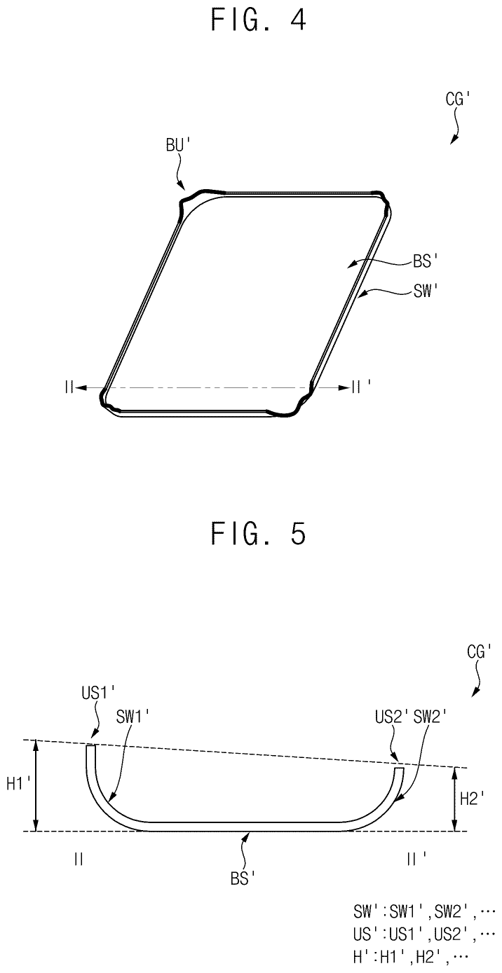

FIG. 3 is a cross-sectional view taken along line I-I′ of FIG. 2.

Referring to FIG. 3, in an embodiment, the cover glass CG includes the side wall SW extending in the direction crossing the bottom surface BS, and a height H of an upper surface US of the side wall SW may be constant.

For example, in a cross-sectional view, the cover glass CG may include a first side wall SW1 and a second side wall SW2. In this case, the first side wall SW1 is a right side wall, and the second side wall SW2 is a left side wall. The cross-section may be defined by the first direction and the third direction. Each of the first side wall SW1 and the second side wall SW2 may protrude from the bottom surface BS in the third direction (e.g., thickness direction). The first side wall SW1 and the second side wall SW2 may face each other in the first direction. In this case, the first side wall SW1 may be protruded from one end of bottom surface BS, and second side walls SW2 may be protruded from the other end of the bottom surface BS.

As depicted in FIG. 3, the cover glass CG includes the first side wall SW1 and the second side wall SW2, however, the present disclosure is not limited thereto. For example, in the plan view, the cover glass CG may further include a third side wall and a fourth side wall. For example, the third side wall may cross both the first side wall SW1 and the second side wall SW2. In addition, the fourth side wall may also cross both the first side wall SW1 and the second side wall SW2.

A first height H1 of the first upper surface US1 of the first side wall SW1 and a second height H2 of the second upper surface US2 of the second side wall SW2 may be substantially the same. The first height H1 may mean a vertical distance from the upper surface of the first upper surface US1 to the bottom surface of the bottom surface BS. The second height H2 may mean a vertical distance from the upper surface of the second upper surface US2 to the bottom surface of the bottom surface BS.

When the cover glass CG further includes the third side wall and the fourth side wall, the first level H1 of the first upper surface US1 of the first side wall SW1, the second level H2 of the second upper surface US2 of the second side wall SW2, a third height of the third upper surface of the third side wall, and a fourth height of the fourth upper surface of the fourth side wall may be substantially a same. The third height may mean a vertical distance from the upper surface of the third upper surface to the bottom surface of the bottom surface BS. The fourth height may mean a vertical distance from the upper surface of the fourth upper surface to the bottom surface of the bottom surface BS.

As the height of the upper surface US of the side wall SW of the cover glass CG is constant, occurrence of fastening defects may be prevented. For example, the first side wall SW1 of the cover glass CG may cover the fourth side surface of the display device. The second side wall SW2 may cover the second side surface (e.g., the second side surface SS2 of FIG. 1). The third side wall may cover the first side surface (e.g., the first side surface SS1 of FIG. 1). The fourth side wall may cover the third side surface. However, the present disclosure is not limited thereto. For example, the third side wall may cover the third side surface, and the fourth side wall may cover the first side surface.

In FIG. 3, the side wall SW of the cover glass CG includes four double curved surfaces of constant height, however the present disclosure is not limited thereto.

For example, the display device may be a smart watch. In this case, the planar shape of the front surface (e.g., front surface S1 of FIG. 1) may be circular. In this case, the side wall SW may include a single curved surface protruded from the bottom surface BS. For example, the side wall SW may have a circular shape capable of covering the front surface.

FIG. 4 is a perspective view of a cover glass according to a comparative embodiment.

Referring to FIGS. 1 and 4, to protect the surface of the display device 1000, the cover glass CG′ according to the comparative embodiment includes the bottom surface BS′ and a side wall SW′. In the case of the cover glass CG′ according to the comparative embodiment, a height of the side wall SW′ might not be constant.

For example, the bottom surface BS′ may have the substantially flat surface. The bottom surface BS′ may be disposed to cover the front surface S1 of the display device 1000 so that the bottom surface BS′ may protect the front surface S1 of the display device 1000.

For example, the side wall SW′ may be protruded from the bottom surface BS′. For example, the bottom surface BS′ may be parallel to the plane defined by the first direction and the second direction, and the side wall SW′ may be protruded from the bottom surface BS in the third direction (e.g., thickness direction). The side wall SW′ may be disposed to cover the side surface SS of the display device 1000 so that the side wall SW′ may protect the side surface SS of the display surface 1000.

Similarly, the side wall SW′ may include the double curved surface. However, unlike the cover glass CG of FIG. 2, the cover glass CG′ of FIG. 4 may further include a burr BU′ on the double curved surface. Accordingly, the cover glass CG′ of FIG. 4 may be determined to have a height defect. The burr BU′ may refer to a formation of unintended protrusions in a molded product.

For example, the cover glass CG′ according to the comparative embodiment may be formed of a pre-glass (e.g., a pre-glass PG of FIG. 12). For example, the pre-glass may be 2D-glass including flat surfaces.

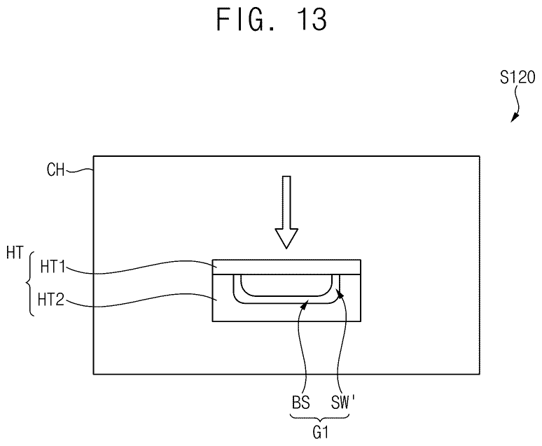

The pre-glass may be bent to form primary processed glass including the double curved surface (e.g., a primary processed glass G1 of FIG. 13). In an embodiment, the primary processed glass may include the burr BU′, or the height of the upper surface of the side wall SW′ might not be constant due to a lack of a polishing process after a thermoforming process. In this case, all of the heights of the upper surface of the side walls SW′ may be different, or some of the heights of the upper surface of the side walls SW′ may be different each other.

For example, the primary processed glass may be 4D-glass including the double curved surface. The 4D-glass may be a glass in which the bottom surface BS′ and the side wall SW′ are composed of four surfaces. However, the present disclosure is not limited thereto. For example, the primary processed glass may have various shapes including the double curved surfaces. For another example, the primary processed glass may have various shapes including the single curved surface.

To manufacture a mold that prevents the burr BU′ defects, multiple molds corresponding to a final shape of the cover glass CG′ may be required. Accordingly, manufacturing costs may increase and manufacturing time due to mold replacement may increase.

On the other hand, changing the design logic to prevent the burr BU′ defects may be complex and difficult due to variety of process factors.

On the other hand, if the cover glass CG′ with the height defect is discarded, the fastening defects due to the height defect may be prevented, however, yield may be reduced.

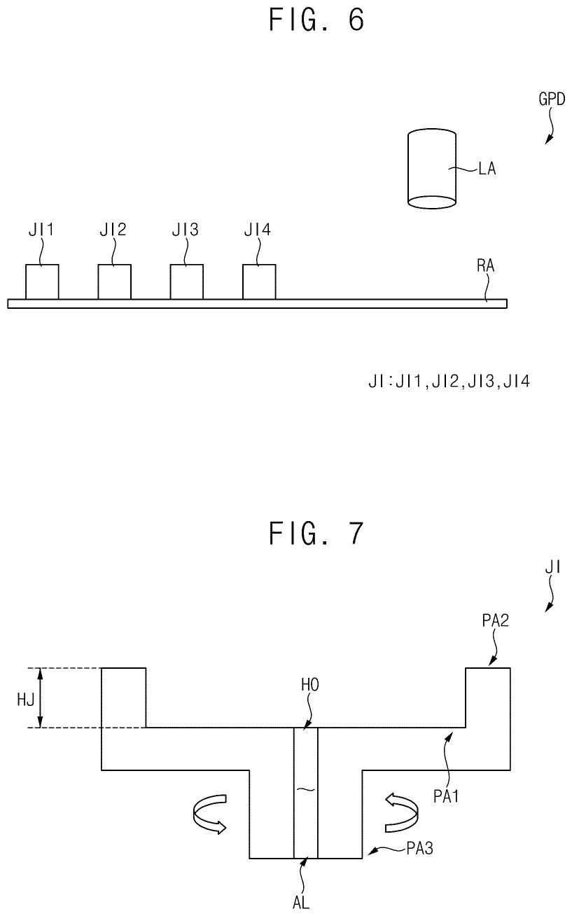

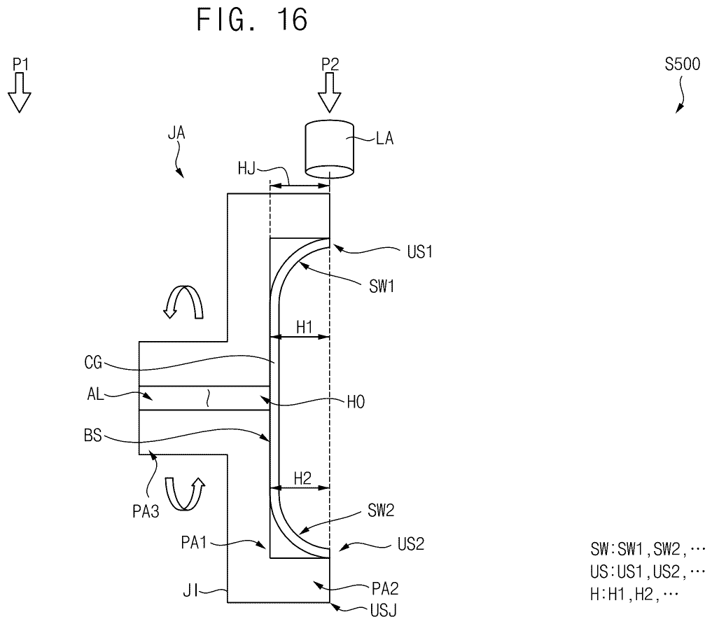

A glass processing device (e.g., a glass processing device GPD of FIG. 6) according to an embodiment of the present disclosure has a simple equipment configuration, and the glass processing method using the glass processing device may easily remove the burr BU′. A detailed description of the glass processing method and the glass processing device performing the glass processing method will be described below with reference to FIG. 16.

FIG. 5 is a cross-sectional view taken along line II-II′ of FIG. 4.

Referring to FIGS. 1 and 5, the cover glass CG′ according to the comparative embodiment may include a side wall SW′ and a bottom surface BS′, and the height H′ of the upper surface US′ of the side wall SW′ might not be constant.

For example, in the cross-sectional view, the cover glass CG′ may include a first side wall SW1′ and a second side wall SW2′. In this case, the first side wall SW1′ is a left side wall, and the second side wall SW2′ is a right side wall. The cross-section may be defined by the first direction and the third direction. Each of the first side wall SW1′ and the second side wall SW2′ may be protruded from the bottom surface BS′ in the third direction (e.g., thickness direction). The first side wall SW1′ and the second side wall SW2′ may face each other in the first direction. For example, the first side wall SW1′ may be protruded from one side of the bottom surface BS′, and the second side wall SW2′ may be protruded from the other side of the bottom surface BS′.

A first height H1′ of the first upper surface US1′ of the first side wall SW1′ and the second height H2′ of the second upper surface US2′ of the second side wall SW2′ may be different from each other. In this case, the first height H1′ may mean the vertical distance from the upper surface of the first upper surface US1′ to the bottom surface of the bottom surface BS′. The second level H2′ may mean the vertical distance from the upper surface of the second upper surface US2′ to the bottom surface of the bottom surface BS′. For example, the first height H1′ may be longer than the second height H2′. However, this is only an example, and in another example, the first height H1′ may be shorter than the second height H2′.

As depicted in FIG. 4, when bending the pre-glass to form the cover glass CG′ according to the comparative embodiment, the height of the upper surface of the side wall of the cover glass CG′ might not be constant. In this case, the fastening defects due to a height difference between the side walls may be occurred. The height difference between the side walls may cause poor connection with the set. The fastening defect may mean that the display device 1000 of FIG. 1 is exposed without being covered or is lifted.

The height difference between the side walls may be caused by the height difference of the mold used in the thermoforming process, heat distribution of a thermoforming equipment, pressure distribution, or the like.

However, the height difference may be easily eliminated using the glass processing device GPD and the glass processing method according to an embodiment of the present disclosure. Accordingly, the occurrence of the fastening defect may be prevented.

Hereinafter, a detailed description of the glass processing device GPD and the glass processing method according to an embodiment of the present disclosure will be described with reference to FIGS. 6, 7, 8, 9, 10, 11, 12, 13, 14, 15, and 16.

FIGS. 6, 7, and 8 are views illustrating the glass processing device according to an embodiment of the present disclosure.

For example, FIG. 6 is a view illustrating the glass processing device GPD. FIG. 7 is a view

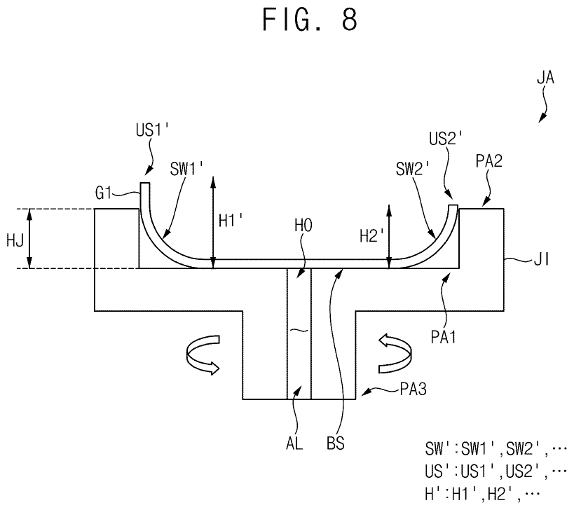

illustrating a jig JI included in the glass processing device GPD. FIG. 8 is a view illustrating a jig assembly JA in which an object to be processed (e.g., primary processed glass G1 of FIG. 8) is seated on the jig JI of FIG. 7.

As depicted in FIGS. 6, 7, and 8, in an embodiment, the glass processing device GPD includes the jig JI, a laser LA, and a driving device RA.

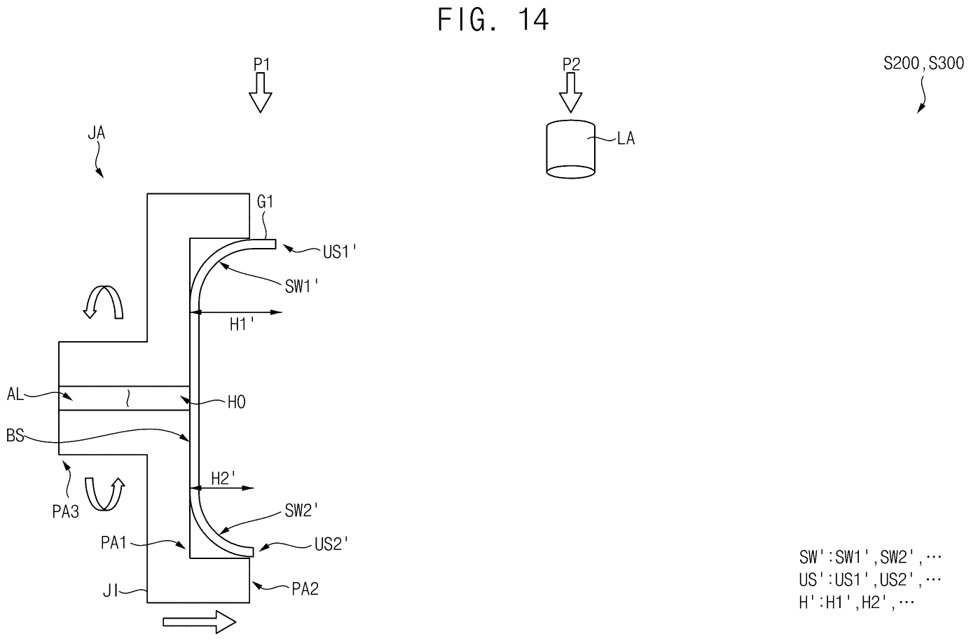

In an embodiment, the object to be processed may be seated on the jig (e.g., a first jig JI1) to form the jig assembly JA, and the laser LA may be fixed at a position (e.g., a second position P2 of FIG. 14) spaced apart from a position where the object to be processed is seated on the jig (e.g., a first position P1 of FIG. 14).

In an embodiment, the jig assembly JA may be transported in one direction. For example, the jig JI may be transported in the one direction along the driving device RA. For example, the object to be processed may be seated on the jig JI. The object to be processed may be transported in the one direction together with the jig JI. Accordingly, the jig assembly JA may become closer to the laser LA or may move away from the laser LA.

In an embodiment, the laser beam emitted from the laser LA may process the object to be processed (e.g., remove a portion of the side wall SW′.

In FIG. 6, the jig assembly JA is explained as being transported along the driving device RA (e.g., a rail), however, the present disclosure is not limited thereto. For example, the jig assembly JA may be transported in a variety of ways.

In an embodiment, the glass processing device GPD may include a plurality of jigs JI. For example, the jig JI may include the first jig JI1, a second jig JI2, a third jig JI3, and a fourth jig JI4. However, the present disclosure is not limited thereto. For example, the number of the jigs JI may be at least one. In this case, the number of jigs JI may be one, two, and three. In another example, the number of jigs JI may be more than four.

In an embodiment, the jig JI may be transported in the one direction. In an embodiment, the plurality of jigs JI may be sequentially transported in the one direction. For example, the first jig JI1, the second jig JI2, the third jig JI3, and the fourth jig JI4 may sequentially move to the laser LA along the driving device RA. Accordingly, the object to be processed seated on the first jig JI1, the object to be processed seated on the second jig JI2, the object to be processed seated on the third jig JI3, and the object to be processed seated on the fourth jig JI4 may be sequentially processed by the laser LA.

For example, the object to be processed may be a glass. For example, the glass before processing (i.e., the first processed glass G1 of FIG. 8) may move to the laser LA in the one direction along the driving device RA, and the glass after the processing (i.e., the cover glass CG of FIG. 3) may move away from the laser LA in the same direction along the driving device RA.

Referring to FIGS. 7 and 8, the jig assembly JA includes the jig JI and object to be processed seated on the jig JI. For example, the jig assembly JA includes the jig JI and the primary processed glass G1 seated on the jig JI.

As described above, the burr and/or the height defect may occur during the thermoforming process using the preliminary glass. To prevent this, a planarization process using the glass that has undergone the thermoforming process may be further performed. For convenience of explanation, the glass that underwent the thermoforming process using the preliminary glass is referred to as the primary processed glass G1.

In an embodiment, the primary processed glass G1 may include the flat bottom surface BS and the side wall SW′ extending in the direction crossing the bottom surface BS.

For example, the primary processed glass G1 may include the first side wall SW1′ and the second side wall SW2′. Each of the first side wall SW1′ and the second side wall SW2′ may be protruded from the bottom surface BS in the third direction. The first side wall SW1′ and the second side wall SW2′ may face each other in the first direction. In this case, the first side wall SW1′ may be protruded from one end of the bottom surface BS, and the second side wallSW2′ may be protruded from the other end of the bottom surface BS.

In an embodiment, the height H′ of the upper surface US′ of the side wall SW′ of the primary processed glass G1 might not be constant. For example, the first level H1′ of the first upper surface US1′ of the first side wall SW1′ and the second level H2 of the second upper surface US2′ of the second side wall SW2′ may be different. In this case, the first level H1′ of the first upper surface US1′ of the first side wall SW1′ may be longer than the second level H2 of the second upper surface US2′ of the second side wall SW2′. However, in another example, the first level H1′ of the first upper surface US1′ of the first side wall SW1′ may be shorter than the second level H2 of the second upper surface US2′ of the second side wall SW2′.

In an embodiment, as depicted in FIG. 7, the jig JI includes a first part PA1, a second part PA2, and a third part PA3.

In an embodiment, as depicted in FIG. 8, the primary processed glass G1 is seated in the first part PA1. For example, the bottom surface BS of the primary processed glass G1 may be seated on the first part PA1.

In an embodiment, a hole HO may be defined in the first part PA1 and the third part PA3 penetrating through the upper surface of the first part PA1 to the bottom surface of the third part PA3. The hole HO may be connected to a pump that provides suction pressure. An airline AL through which air moves may be disposed between the hole HO and the pump. For example, the first part PA1 may prevent the primary processed glass G1 from moving due to the suction pressure.

As depicted in FIGS. 7 and 8, the suction pressure provided by the hole HO is explained as being through a single path, however, the present disclosure is not limited thereto. For example, the suction pressure may be provided by a plurality of paths branching from the pump.

For example, a plurality of holes HO may be formed in the first part PA1 and the third part PA3. To provide uniform absorption pressure, the plurality of holes may be formed symmetrically in the first part PA1. However, the present disclosure is not limited thereto. The shape and structure of the jig JI may be changed in various ways.

The second part PA2 may prevent the primary processed glass G1 from being separated from the first part PA1 when the jig JI rotates. For example, the side wall SW′ of the primary processed glass G1 may be in contact with the second part PA2 so that the second part PA2 may prevent the primary processed glass G1 from being separated from the jig JI.

In an embodiment, the second part PA2 may be protruded and extended from the first part PA1 in a direction opposite to the direction in which the suction pressure acts (e.g., the third direction or thickness direction). In this case, the second part PA2 may be surrounded along the edge of the first part PA1.

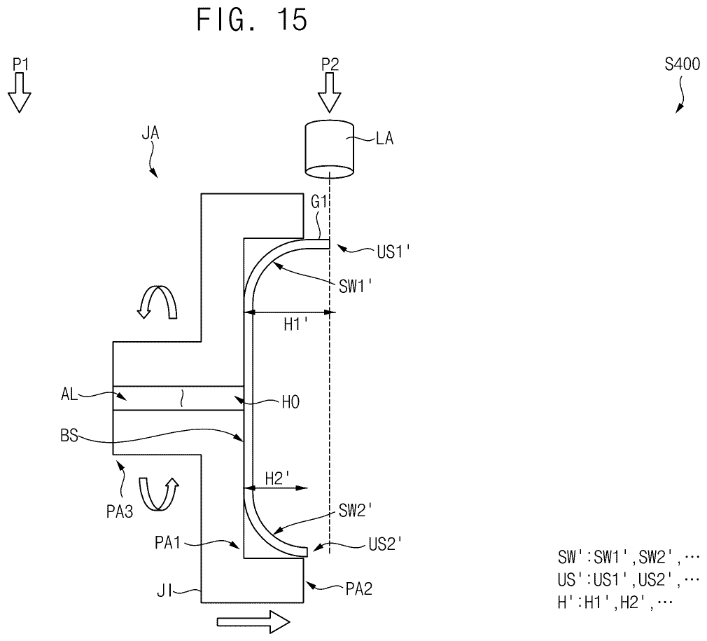

For example, the second part PA2 may define a Maginot line that must be processed (e.g., cut) by the laser LA in the primary processed glass G1. A detailed description of this will be described below with reference to FIGS. 15 and 16.

The third part PA3 may support the first part PA1 and the second part PA2. In an embodiment, the third part PA3 may extend from the first part PA1 in a direction in which the suction pressure acts (e.g., the third direction or thickness direction). For example, the airline AL may be formed to pass through the third part PA3 from the seating surface of the first part PA1.

In an embodiment, the jig JI may rotate around an imaginary axis passing through the middle of the third part PA3 of the jig assembly JA. Accordingly, the first part PA1 connected to the third part PA3 may also rotate. To this end, the third part PA3 may be connected to a motor that provides rotational force.

In an embodiment, the jig assembly JA may be transferred in one direction while rotating. As shown in FIG. 7, in an embodiment, as the third part PA3 rotates, the first part PA1 which is connected to the third part PA3 may also rotate. Accordingly, the primary processed glass G1 seated on the first part PA1 may also rotate with the same direction.

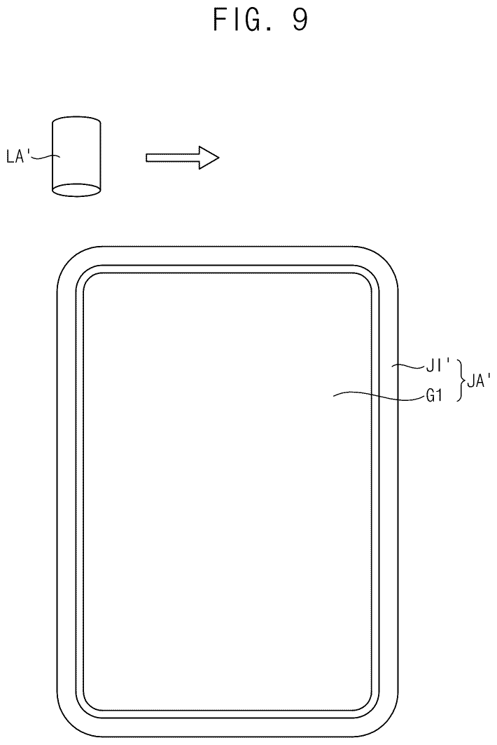

FIG. 9 is a view illustrating a glass processing device according to a comparative embodiment.

Referring to FIG. 9, the glass processing device according to the comparative embodiment includes a jig assembly JA′. The jig assembly JA′ may include a jig JI′ and the primary processed glass G1 seated on the jig JI′.

As described above with reference to FIG. 5, the primary processed glass G1 may include the flat bottom surface BS and the side wall SW′ extending in the direction crossing the bottom surface BS, and the height H′ of the upper surface US′ of the side wall SW′ might not be constant. For example, the first height H1′ of the first side wall SW1′ may be longer than the second height H2′ of the second side wall SW2′.

In this case, the primary processed glass G1 may be fixed to the jig JI′ by the suction pressure.

For example, the jig assembly JA′ of FIG. 9 may be fixed unlike the jig assembly JA of FIG. 6, and a laser LA′ may be moved in one direction. For example, the laser LA′ may scan from a first end to a second end of the jig assembly JA′. The second end may be opposite to the first end in a scanning direction of the laser LA′. In this case, the laser LA′ may move from the left side of the jig assembly JA′ to the right side of the jig assembly JA′.

When the laser LA′ moves, an edge portion of the primary processed glass G1 may be excessively cut. Accordingly, a shape of a cutting surface may be bumpy, thereby the surface of the edge portion of the primary processed glass G1 may be uniform.

However, in a case of the glass processing device GPD according to an embodiment of the present disclosure described above with reference to FIGS. 6, 7, and 8, the laser LA is fixed, and the jig assembly JA moves linearly and rotationally. As the laser LA is fixed and the jig assembly JA moves and rotates, the edge portion of the primary processed glass G1 may be cut uniformly. Accordingly, a shape of a cutting surface may be uniformly formed.

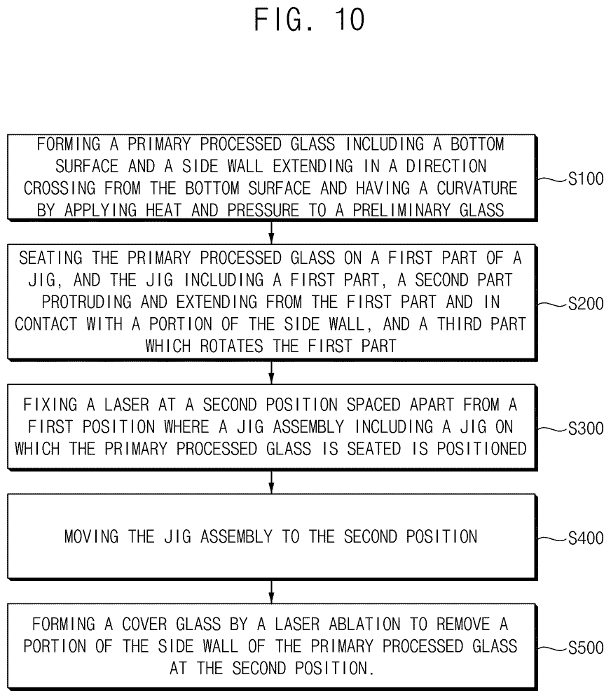

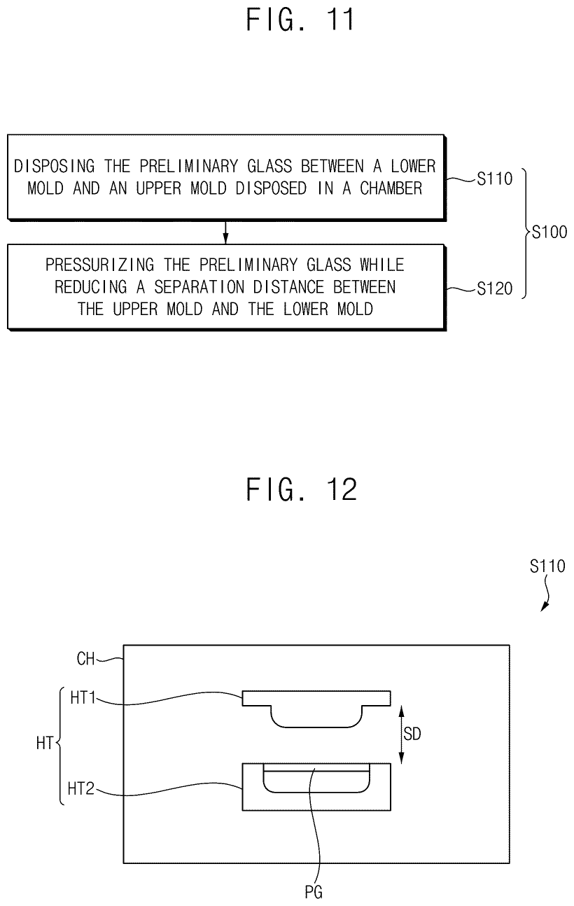

FIGS. 10, 11, 12, 13, 14, 15, and 16 are views illustrating a glass processing method according to an embodiment of the present disclosure. Hereinafter, descriptions that overlap with those described above with reference to FIGS. 1, 2, 3, 6, 7, and 8 will be omitted or simplified.

For example, the glass processing method may be performed using the glass processing device according to an embodiment of the present disclosure described above with reference to FIGS. 6, 7, and 8.

Referring to FIGS. 10, 11, 12, and 13, in an embodiment, the primary processed glass including the bottom surface BS and the side wall SW′ extending in the direction crossing from the bottom surface BS and having the curvature may be formed by applying heat and pressure to a preliminary glass PG (S100). In an embodiment, the preliminary glass may be disposed between a lower mold HT2 and an upper mold HT1 positioned on the lower mold disposed in a chamber CH (S110), and the preliminary glass may be pressurized while reducing a separation distance between the upper mold and the lower mold (S120).

In an embodiment, the preliminary glass PG may be formed from the primary processed glass G1 in a thermoforming device HT. The primary processed glass G1 may have a different shape from the preliminary glass PG. For example, the primary processed glass G1 may have a flat shape, and the preliminary glass PG may have a shape including the double curved surface. However, the present disclosure is not limited thereto. For example, depending on the shape of the thermoforming device HT, the primary processed glass G1 may have various shapes.

In an embodiment, the thermoforming device HT may be disposed within the chamber CH. The thermoforming device HT may include an upper mold HT1 and the lower mold HT2. The upper mold HT1 may be positioned above the lower mold HT2. The upper mold HT1 and the lower mold HT2 may be spaced apart from each other by a separation distance SD. In this case, the separation distance SD between the upper mold HT1 and the lower mold HT2 may be movably adjusted (increased or decreased).

In an embodiment, the preliminary glass PG may be disposed between the upper mold HT1 and the lower mold HT2 (S110). In this case, the preliminary glass PG may be snuggly disposed on the lower mold HT2. In an embodiment, a temperature of the thermoforming device HT may increase as the chamber CH is heated. In other words, as the chamber CH is heated, the upper mold HT1 and the lower mold HT2 may also be heated. In other words, as the chamber CH is heated at the desired temperature, the preliminary glass PG may also be heated.

In an embodiment, pressure may be provided to the preliminary glass PG as the separation distance SD between the upper mold HT1 and the lower mold HT2 is reduced. As the upper mold HT1 and lower mold HT2 are heated, heat may also be provided to the preliminary glass PG. Accordingly, the first processed glass G1 may be formed (S120) by heat and pressure.

For example, each of the upper mold HT1 and the lower mold HT2 may include graphite. Accordingly, the primary processed glass G1 that has completed the thermoforming process may include a plurality of pores formed by the graphite.

Referring to FIGS. 10 and 14, in an embodiment, the primary processed glass G1 may be seated on the jig JI that moves linearly toward the fixed laser LA (S200, S300).

As described previously, in an embodiment, the jig JI may include the first part PA1, the second part PA2, and the third part PA3.

Furthermore, the primary processed glass G1 may include the bottom surface BS and the side wall SW′ protruding from the bottom surface BS, and the primary processed glass G1 including the double curved surface may be seated on the first part PA1.

In an embodiment, the second part PA2 may be protruded from the first part PA1 and may contact the portion of the side wall SW′ of the primary processed glass G1. In this case, the first side wall SW1′ and the second side wall SW2′ of the primary processed glass G1 may contact the second part PA2. For example, the second part PA2 may define the Maginot line that must be processed (e.g., cut) by the laser LA in the primary processed glass G1. A detailed description of this will be provided below with reference to FIGS. 15 and 16.

In an embodiment, the jig assembly JA may rotate around the third part PA3 which is attached to the first part PA1. In other words, as the jig assembly JA rotates, the primary processed glass G1 seated on the jig JI may also rotate with the same direction as the third part PA3. The primary processed glass G1 seated on the first part PA1 may be processed by the laser LA in a rotating state. A detailed description of this will be described blow with reference to FIGS. 15 and 16.

In an embodiment, the primary processed glass G1 seated on the jig JI may be placed at the first position P1. In one embodiment, the primary processed glass G1 may be fixedly attached to the jig JI by the suction pressure provided from the first part PA1. Accordingly, the jig assembly JA in which the jig JI and the object to be processed (e.g., the primary processed glass G1) on the jig JI may be configured.

In an embodiment, the hole HO may be formed in the first part PA1 and the third part PA3, the hole HO may be connected to the airline AL through which air moves, and the airline AL may be connected to the pump located outside of the jig assembly JA or attached to the bottom of the jig assembly JA. Accordingly, the suction pressure that fixes the primary processed glass G1 may be provided through the hole.

Referring to FIGS. 10 and 15, in an embodiment, the jig assembly JA may be moved from the first position P1 to the second position P2 (S400).

In an embodiment, the primary processed glass G1 seated on the jig JI may be positioned at the first position P1, and the laser LA may be fixed at the second position P2. In other words, in an embodiment, the jig assembly JA may be linearly moved from the first position P1 to the second position P2 by the driving device (e.g., driving device RA of FIG. 6), the laser LA2 positioned perpendicular to the linear direction of the jig assembly JA may emit a laser beam while being fixed at the second position P2.

For example, the first position P1 may mean a position spaced apart from the laser LA. For example, the first position P1 might not be able to be processed by the laser LA, and the second position P2 may be a position that may be processed by the laser LA.

In the above, it has been described that the laser LA is fixed in the position spaced apart from the jig JI, however, the present disclosure is not limited thereto. Firstly, the laser LA may be fixed, the jig JI may be positioned in the position spaced apart from the laser LA, and then the primary processed glass G1 may be seated on the jig JI.

Referring to FIGS. 10, 15, and 16, in an embodiment, at the second position P2, the cover glass CG may be formed by the laser LA to remove the edge portion of the side wall SW′ of the primary processed glass G1 (S500).

In an embodiment, at the second position P2, the laser LA may process the primary processed glass G1 while the jig assembly JA rotates around the third part PA3. As described above, as the jig assembly JA rotates, the primary processed glass G1 may also rotate.

As depicted in FIG. 16, at the second position P2, the laser LA removes the portion of the side wall SW′ of the primary processed glass G1 while the jig assembly JA rotates around an imaginary axis passing through the middle of the third part PA3 of the jig assembly JA. For example, at the second position P2, the laser LA may cut the edge portion of the side wall SW′ of the primary processed glass G1 while the jig assembly JA rotates one or more times around an imaginary axis passing through the middle of the third part PA3 of the jig assembly JA.

For example, the laser LA may be infrared with a wavelength of about 1064 nanometers (nm).

For example, the laser LA may be a solid state laser. A medium of the solid state laser may be ND:YAG, Nd:YVO4, or the like.

For example, a spot diameter of the laser LA may be between about 20 and about 30 micrometers (um). For example, as the spot diameter increases, power density may decrease, and as the spot diameter decreases, the power density may increase. In other words, at a same power, as the spot diameter becomes smaller (i.e., as the power density increases), the laser beam may be concentrated and irradiated to the object to be ablated.

For example, a pulse width of a laser LA may be about a nanosecond (ns) scale. The pulse width may mean that the laser LA may be repeatedly turned on and off, and the on-off interval may be about a nanosecond.

For example, a duty of the laser LA may be about 50%. The duty (i.e., pulse output) may refer to a proportion of on in one pulse. In other words, when the duty is about 50%, the number of on and off times in one pulse may be the same.

However, the present disclosure is not limited thereto. For example, a specification (e.g., spot diameter, wavelength, pulse width, and duty ratio) of the laser LA and the number of rotations and the rotational speed of jig assembly JA at the second position P2 may be variously changed depending on the shape of the primary processed glass G1 and the shape of the cover glass CG which is the final finished product.

In an embodiment, the height H′ of the upper surface US′ of the side wall SW′ of the primary processed glass G1 before passing through the second position P2 may not be constant, and the height H of the upper surface US of the side wall SW of the primary processed glass G1 that has passed through the second position P2 (i.e., cover glass CG) may be constant. In this case, the edge of the primary processed glass G1 may be ablated or trimmed after passing through the second position P2 by the laser LA.

As shown in FIG. 15, in the side view, the primary processed glass G1 includes the bottom surface BS and the side wall SW′ extending in the direction crossing the bottom surface BS, and the height H′ of the upper surface US′ of the side wall SW′ is not constant. For example, the first height H1′ of the first side wall SW1′ may be longer than the second height H2′ of the second side wall SW2′.

In the cross-sectional view, the primary processed glass G1 may include the first side wall SW1′ and the second side wall SW2′. Each of the first side wall SW1′ and the second side wall SW2′ may be protruded from the bottom surface BS in the third direction (e.g., thickness direction). The first side wall SW1′ and the second side wall SW2′ may face each other in the first direction. In this case, the first side wall SW1′ may be protruded from one end of the primary processed glass G1, and the second side wall SW2′ may be protruded from the other end of the primary processed glass G1.

For example, the first height H1′ of the first upper surface US1′ of the first side wall SW1′ and the second height H2′ of the second upper surface US2′ of the second side wall SW2′ may be different. In this case, the first height H1′ of the first side wall SW1′ may be longer than the second height H2′ of the second side wall SW2′. For example, the height H′ of the upper surface US′ of the side wall SW′ of the primary processed glass G1 before passing the second position P2 due to the burr (e.g., the burr BU′ of FIG. 4) may not be constant. In this case, the fastening defect with other set configurations may be caused.

To prevent this, the glass processing method according to an embodiment of the present disclosure may include a process of flattening the upper surface US′ of the primary processed glass G1 by the laser LA after the thermoforming process.

The process of flattening may mean a process in which the laser beam emitted from the laser LA removes the edge portion (e.g., the burr) of the primary processed glass G1 to maintain a constant level of the upper surface. In this case, after the process of flattening by the laser LA, the edge of the primary processed glass G1 may be ablated to be flattened.

As shown in FIG. 16, in an embodiment, the height H of the upper surface US of the side wall SW of the primary processed glass G1 passing through the second position P2 (i.e., the cover glass CG) may be substantially equal to a height HJ of an upper surface USJ of the second part PA2 of the jig JI. For example, the level HJ of the second part PA2 of the jig JI (e.g., the level of the second part PA2) may be substantially equal to the level H of the side wall SW of the second part PA2 of the jig JI.

As described above, the primary processed glass G1 may be processed using the laser LA until the level of the upper surface of the second part PA2 of the jig JI and the level of the upper surface US of the cover glass CG are at a same level.

For example, when the first height H1′ of the first side wall SW1′ is greater than the second height H2′ of the second side wall SW2′, the first side wall SW1′ may reach the second position P2 before the second side wall SW2′. As the jig assembly JA rotates around the third part P3, the portion of the side wall SW′ of the primary processed glass G1 (e.g., the portion of the first side wall SW1′) may be removed until the first height H1′ is equal to the second height H2′.

For example, when the second part PA2 of the jig JI defines the Maginot line to be processed (e.g., cut) by the laser LA in the primary processed glass G1, while the jig assembly JA rotates, the edge portion of the side wall SW′ of the primary processed glass G1 (e.g., the edge portion of the first side wall SW1′ and the edge portion of the portion of the second side wall SW2′) may be ablated until the first height H1, the second height H2, and the height HJ of the second part PA2 become substantially equal to each other.

For this purpose, for example, the jig JI may include steel use stainless. However, the present disclosure is not limited thereto. In another example, the jig JI may include various materials that may not be removed by the laser LA. On the other hand, a processing end point of the laser LA may be set by additional control device to detect such end point.

Accordingly, the cover glass CG that prevents the fastening defect may be formed.

In the glass processing device and the glass processing method described above, the laser may be fixed, the jig may move linearly toward the laser while rotating, the jig may rotate at the fixed position while the jig may move toward to the laser for the laser process (e.g., ablation process) so that the process of flattening may be performed without restrictions on design (i.e., the shape of the primary processed glass). Accordingly, a yield of the cover glass may be improved.

In addition, the glass processing device and the glass processing method include the plurality of jigs, and thus may continuously perform the process of flattening. Accordingly, the process time may be shortened and the yield may be improved.

In addition, the glass processing device and the glass processing method may control a cutting amount of the cover glass using the level of the jig (e.g., the level of the second part of the jig). Accordingly, the level of the cover glass may be precisely controlled.

The present disclosure should not be construed as being limited to the embodiments set forth herein. Rather, these embodiments are provided so that this present disclosure will be thorough and complete and will fully convey the concept of the present disclosure to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A glass processing method comprising:
forming a primary processed glass by applying heat and pressure to a preliminary glass including a bottom surface and a side wall extending in a direction crossing from the bottom surface and having a curvature;
seating the primary processed glass on a first part of a jig, and the jig including a first part, a second part protruding and extending from the first part and in contact with a portion of the side wall, and a third part which rotates the first part;
fixing a laser at a second position spaced apart from a first position where a jig assembly including a jig on which the primary processed glass is seated is positioned;
moving the jig assembly to the second position; and
forming a cover glass by a laser ablation to remove a portion of the side wall of the primary processed glass at the second position.

2. The glass processing method of claim 1,
wherein the forming of the primary processed glass is accomplished by:
disposing the preliminary glass between a lower mold and an upper mold disposed in a chamber, and
pressurizing the preliminary glass while reducing a separation distance between the upper mold and the lower mold.

3. The glass processing method of claim 2, wherein the chamber, the lower mold, and the upper mold are heated.

4. The glass processing method of claim 1, wherein a height of an upper surface of the side wall of the primary processed glass is not constant at the first position.

5. The glass processing method of claim 1, wherein a height of an upper surface of the side wall of the cover glass becomes constant after the laser ablation at the second position.

6. The glass processing method of claim 5, wherein the height of the upper surface of the side wall of the cover glass is equal to a height of an upper surface of the second part of the jig.

7. The glass processing method of claim 1, wherein,
the jig assembly linearly moves from the first position to the second position, and
at the second position, the laser ablates some portions of the side wall of the primary processed glass while the jig assembly is rotated around an imaginary axis passing through a middle of the jig assembly.

8. The glass processing method of claim 7, wherein, at the second position, the laser ablates some portions of the side wall of the primary processed glass while the jig assembly rotates one or more times around the imaginary axis.

9. The glass processing method of claim 1, wherein the primary processed glass is fixed to the jig by suction pressure provided from the first part of the jig.

10. The glass processing method of claim 1, wherein,
the jig is plural, and
the plurality of jigs are sequentially moved from the first position to the second position.

11. A glass processing device comprising:
a jig including a first part on which a primary processed glass including a bottom surface and a side wall extending in a direction crossing from the bottom surface and including a double curved surface is seated, a second part in contact with a portion of the side wall of the primary processed glass protruding and extending from the first part, and a third part attached to the first part, wherein the jig rotates around an imaginary axis passing through a middle of the third part;
a laser that is fixed to a second position spaced apart from a first position where a jig assembly including the jig on which the primary processed glass is seated is positioned, and wherein the laser ablates some portions of the side wall of the primary processed glass at the second position; and
a driving device that transports the jig from the first position to the second position.

12. The glass processing device of claim 11, further comprising:
a chamber;
a lower mold disposed in the chamber; and
an upper mold positioned above the lower mold in the chamber,
wherein the lower mold and the upper mold are spaced apart from each other by a separation distance, and
the separation distance between the lower mold and the upper mold is adjustable.

13. The glass processing device of claim 12, wherein the chamber, the lower mold, and the upper mold are heated.

14. The glass processing device of claim 11, wherein a height of an upper surface of the side wall of the primary processed glass is not constant at the first position.

15. The glass processing device of claim 11, wherein a height of an upper surface of the side wall of the primary processed glass that passes the second position becomes constant after the second position.

16. The glass processing device of claim 15, wherein the height of the upper surface of the side wall of the primary processed glass that passes the second position is equal to a height of an upper surface of the second part of the jig.

17. The glass processing device of claim 11, wherein,
the driving device linearly moves the jig assembly from the first position to the second position, and
at the second position, the laser ablates some portions of the side wall of the primary processed glass while the jig assembly is rotated around the imaginary axis.

18. The glass processing device of claim 17, wherein, at the second position, the laser ablates some portions of the side wall of the primary processed glass while the jig assembly rotates one or more times around the imaginary axis.

19. The glass processing device of claim 11, wherein,
a hole is defined in the first part of the jig, and
a suction pressure is provided in the hole to fix the primary processed glass to the jig.

20. A glass processing method comprising:
forming a primary processed glass including a bottom surface and a side wall extending in a direction crossing from the bottom surface and having a curvature by applying heat and pressure to a preliminary glass;
seating the primary processed glass on a first part of a jig, and the jig including a first part, a second part protruding from the first part and in contact with a portion of the side wall, and a third part attached to the first part;
fixing a laser at a second position spaced apart from a first position where a jig assembly including a jig on which the primary processed glass is seated is positioned;
moving the jig assembly to the second position; and
forming a cover glass by a laser ablation to remove a portion of the side wall of the primary processed glass at the second position,
wherein the forming of the primary processed glass is accomplished by:
disposing the preliminary glass between a lower mold and an upper mold disposed in a chamber, and
pressurizing the preliminary glass while reducing a separation distance between the upper mold and the lower mold, wherein the jig assembly linearly moves from the first position to the second position, and
wherein, at the second position, the laser ablates some portions of the side wall of the primary processed glass while the jig assembly is rotated around an imaginary axis passing through a middle of the jig assembly.
